(19) United States
(12) Patent Application Publication
(10) Pub. No.: US 2014/0156194 A1
(43) Pub. Date: Jun. 5, 2014

(54) DEVIATED WELL LOG CURVE GRIDS WORKFLOW

(71) Applicants: Stephen Lupin, Houston, TX (US); Gerald Chalupsky, College Station, TX (US); Jay Vogt, Houston, TX (US); Kristiaan Joseph, Houston, TX (US)

(72) Inventors: Stephen Lupin, Houston, TX (US); Gerald Chalupsky, College Station, TX (US); Jay Vogt, Houston, TX (US); Kristiaan Joseph, Houston, TX (US)

(73) Assignee: SCHLUMBERGER TECHNOLOGY CORPORATION, Houston, TX (US)

(21) Appl. No.: 14/095,266

(22) Filed: Dec. 3, 2013

Related U.S. Application Data
(60) Provisional application No. 61/733,188, filed on Dec. 4, 2012.

(51) Int. Cl. G01V 11/00

(52) U.S. Cl. CPC G01V 11/002
USPC 702/11

(57) ABSTRACT

A method for displaying an exploration and production (EP) data set of a field having a subterranean formation involves obtaining well logs corresponding to deviated wells in a portion of the field, where the well logs represent measured properties of the subterranean formation, extracting a section of each well log corresponding to a horizontal leg of a deviated well, extrapolating data items in the section of each well log to generate extrapolated data items forming the EP data set, where extrapolated data items represent the measured properties combined with a corresponding spatial coordinate across the geological surface, and displaying the numerous extrapolated data items of the EP data set.

### CROSS-REFERENCE TO RELATED APPLICATIONS

This application claims benefit under 35 U.S.C. §119(e) to U.S. Provisional Patent Application Ser. No. 61/733,188, filed on Dec. 4, 2012, and entitled, “HORIZONTAL WELL LOG CURVE GRIDS WORKFLOW.”

### BACKGROUND

Operations, such as geophysical surveying, drilling, logging, well completion, and production, are performed to locate and gather valuable downhole fluids. Surveys are often performed using acquisition methodologies, such as well logging, seismic mapping, resistivity mapping, etc. to generate well logs or images of underground formations. These well logs or images are often analyzed to determine the presence of subterranean assets, such as valuable fluids or minerals, or to determine if the formations have characteristics suitable for storing fluids. Although the subterranean assets are not limited to hydrocarbons such as oil, throughout this document, the terms “oilfield” and “oilfield operation” may be used interchangeably with the terms “field” and “field operation” to refer to a site where any types of valuable fluids or minerals can be found and the activities required to extract them. The terms may also refer to sites where substances are deposited or stored by injecting them into the surface using boreholes and the operations associated with this process. Further, the term “field operation” refers to a field operation associated with a field, including activities related to field planning, wellbore drilling, wellbore completion, and/or production using the wellbore.

Models of subsurface hydrocarbon reservoirs and oil wells are often used in simulation (e.g., in modeling oil well behavior) to increase yields and to accelerate and/or enhance production from oil wells. Seismic and well log interpretation tools and simulation programs can include numerous functionalities and apply complex techniques across many aspects of modeling and simulating. Such programs include a large suite of tools and different programs. Users of such systems may spend many hours per day working with these tools in an effort to optimize geological interpretations and reservoir engineering development scenarios.

### SUMMARY

In general, in one aspect, the invention relates to a method for displaying an exploration and production (EP) data set during an EP tool session of a field having a subterranean formation. The method includes obtaining a plurality of well logs corresponding to a plurality of deviated wells in a portion of the field, wherein the plurality of well logs represent measured properties of the subterranean formation, extracting, by a computer processor, a section of each well log of the plurality of well logs, the section corresponding to a horizontal leg of a deviated well of the plurality of deviated wells, wherein the horizontal leg is within a pre-determined depth range traversed by a geological surface in the subterranean formation, extrapolating, by the computer processor, a plurality of data items in the section of each well log to generate a plurality of extrapolated data items forming the EP data set, wherein the plurality of extrapolated data items represent the measured properties combined with a corresponding spatial coordinate across the geological surface, and displaying the plurality of extrapolated data items of the EP data set.

Other aspects of the invention will be apparent from the following detailed description and the appended claims.

### BRIEF DESCRIPTION OF DRAWINGS

The appended drawings illustrate several embodiments of deviated well log curve grids workflow and are not to be considered limiting of its scope, for deviated well log curve grids workflow may admit to other equally effective embodiments.

FIG. 1.1 is a schematic view, partially in cross-section, of a field in which one or more embodiments of deviated well log curve grids workflow may be implemented.

FIG. 1.2 shows an exploration and production computer system in accordance with one or more embodiments.

FIG. 2 shows a flowchart of a method in accordance with one or more embodiments.

FIGS. 3.1, 3.2, 3.3, 3.4, 3.5, and 3.6 show examples of deviated well log curve grids workflow in accordance with one or more embodiments.

FIG. 4 depicts a computer system using which one or more embodiments of deviated well log curve grids workflow may be implemented.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

One or more aspects of the invention identifies lithology trends from deviated well logs. The term “well log” refers to a continuous measurement of formation properties, obtained using electrically powered instruments traversing a well path (i.e., path of a well bore). The measurements in the well log is recoded versus depth or time, or both, of one or more physical quantities in or around a well. The term “well log curve” refers to the well log displayed as a curve along an axis representing the well path. The well log and/or well log curve may be analyzed to infer properties and make decisions about drilling and production operations.

The term “scatter data” refers to data items that define properties of a formation at various locations throughout a two dimensional (2D) or three dimensional (3D) volume. In other words, each data item may identify a property of the formation at a particular location, and the set of data items in the scatter data are at various locations spanning the two dimensional (2D) or three dimensional (3D) volume representing at least a portion of the formation. The data items in the scatter data may be measured properties of the subterranean formation or information derived therefrom. In particular, the scatter data is not limited to locations along any particular well path.

Embodiments of deviated well log curve grids workflow provide a graphical way for a user to view a large number of well log curves. In one or more embodiments, relevant portions of the large number of well log curves are extracted and converted into scatter data for viewing subterranean information across a geological surface. For example, lithology trends may be discerned by viewing extrapolation of such scatter data. The lithology trends may be automatically determined by analyzing such extrapolated scatter data.

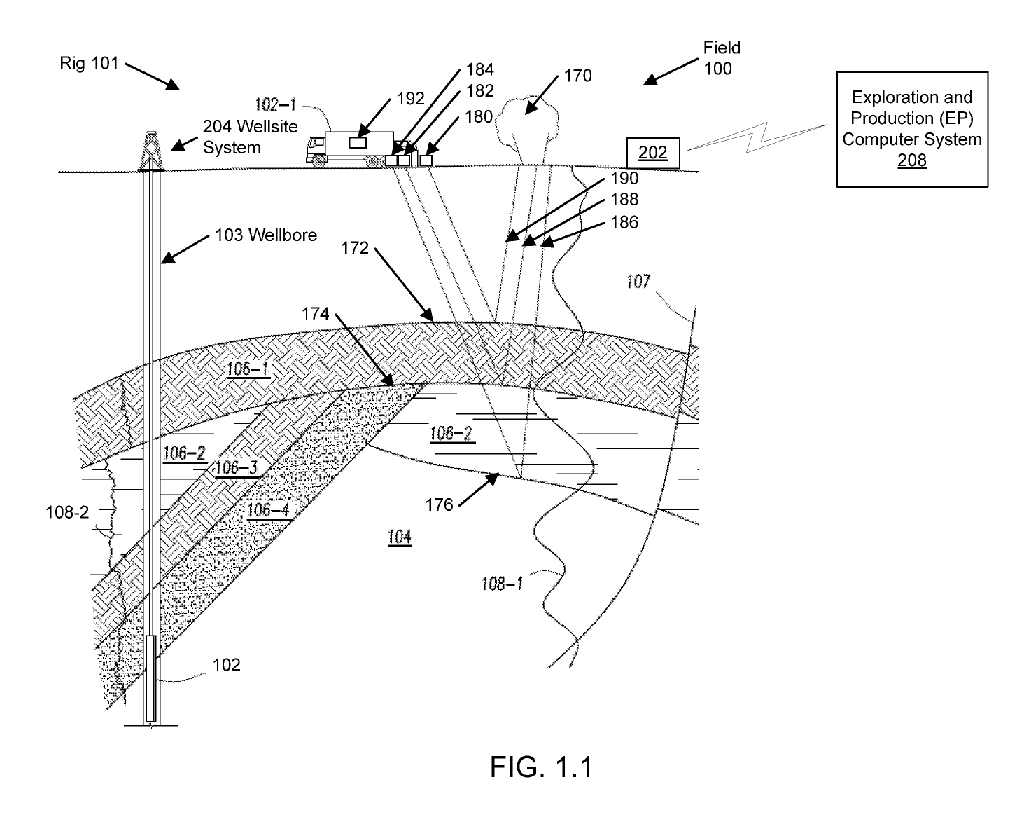

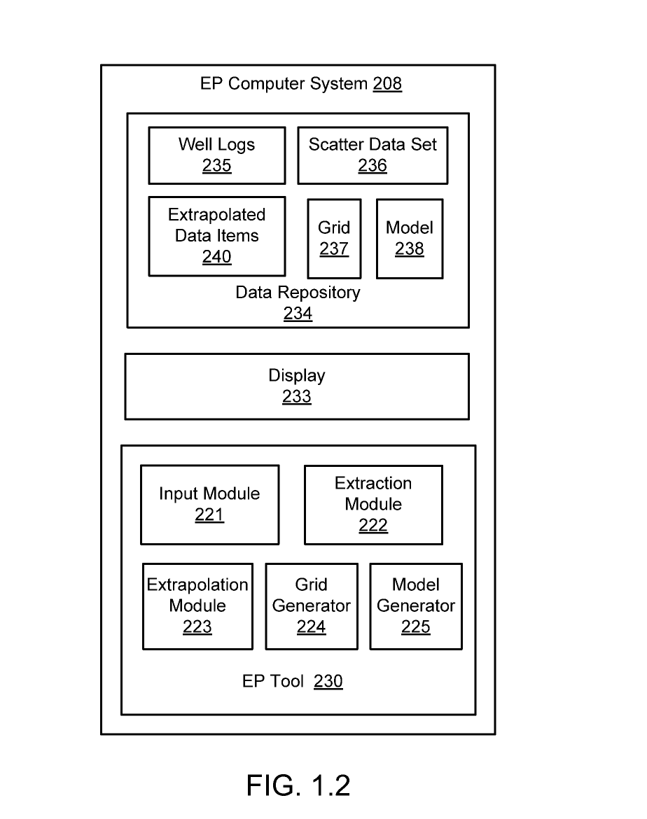

FIG. 1.1 depicts a schematic view, partially in cross section, of a field (100) in which one or more embodiments of deviated well log curve grids workflow may be implemented. In one or more embodiments, one or more of the modules and elements shown in FIG. 1.1 may be omitted, repeated, and/or substituted. Accordingly, embodiments of deviated well log curve grids workflow should not be considered limited to the specific arrangements of modules shown in FIG. 1.1.

As shown in FIG. 1.1, the subterranean formation (104) includes several geological structures (106-1 through 106-4). As shown, the formation has a sandstone layer (106-1), a limestone layer (106-2), a shale layer (106-3), and a sand layer (106-4). A fault line (107) extends through the formation. In one or more embodiments, various survey tools and/or data acquisition tools are adapted to measure the formation and detect the characteristics of the geological structures of the formation. The outputs of these various survey tools and/or data acquisition tools, as well as data derived from analyzing the outputs, are considered as part of the survey information. Throughout this disclosure, the terms “geological structure,” “layer,” and “geological surface” may be used interchangeably depending on context. A geological surface may be one or more layers of rocks, which have been displaced from a normal horizontal position by the forces of nature into folds, fractures and faults. The geological surface may be another subsurface formation without departing from the scope of one or more embodiments. Further, the terms “well log” and “well log curve” may be used interchangeably depending on context.

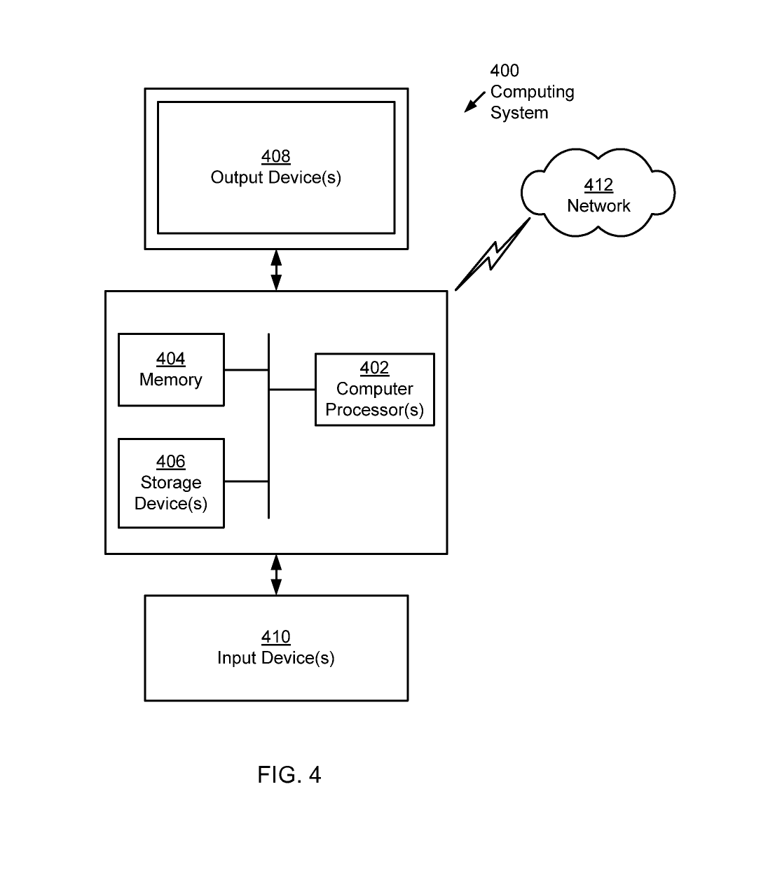

As shown in FIG. 1.1, seismic truck (102-1) represents a survey tool that is adapted to measure properties of the subterranean formation in a seismic survey operation based on sound vibrations. One such sound vibration (e.g., 186, 188, 190) generated by a source (170) reflects off a plurality of horizons (e.g., 172, 174, 176) in the subterranean formation (104). Each of the sound vibrations (e.g., 186, 188, 190) is received by one or more sensors (e.g., 180, 182, 184), such as geophone-receivers, situated on the earth's surface. The geophones produce electrical output signals, which may be transmitted, for example, as input data to a computer (192) on the seismic truck (102-1). Responsive to the input data, the computer (192) may generate a seismic data output, which may be logged and provided to a surface unit (202) by the computer (192) for further analysis. The computer (192) may be the computer system shown and described in relation to FIG. 4.

Further as shown in FIG. 1.1, the wellsite system (204) is associated with a rig (101), a wellbore (103), and other wellsite equipment and is configured to perform wellbore operations, such as logging, drilling, fracturing, production, or other applicable operations. Generally, survey operations and wellbore operations are referred to as field operations of the field (100). These field operations may be performed as directed by the surface unit (202).

In one or more embodiments, the surface unit (202) is operatively coupled to the computer (192) and/or a wellsite system (204). In particular, the surface unit (202) is configured to communicate with the computer (192) and/or the data acquisition tool (102) to send commands to the computer (192) and/or the data acquisition tools (102) and to receive data therefrom. For example, the data acquisition tool (102) may be adapted for measuring downhole properties using logging-while-drilling (“LWD”) tools. In one or more embodiments, surface unit (202) may be located at the wellsite system (204) and/or remote locations. The surface unit (202) may be provided with computer facilities for receiving, storing, processing, and/or analyzing data from the computer (192), the data acquisition tool (102), or other part of the field (100). The surface unit (202) may also be provided with functionally for actuating mechanisms at the field (100). The surface unit (202) may then send command signals to the field (100) in response to data received, for example to control and/or optimize various field operations described above.

Generally, the data received by the surface unit (202) is referred to as the subterranean formation field data set. In one or more embodiments, the subterranean formation field data set represents characteristics of the subterranean formation (104) and may include seismic data, well logs, etc. that relate to porosity, saturation, permeability, natural fractures, stress magnitude and orientations, elastic properties, etc. during a drilling, fracturing, logging, or production operation of the wellbore (103) at the wellsite system (204). For example, data plot (108-1) may be a seismic two-way response time or other types of seismic measurement data. In another example, data plot (108-2) may be a well log, which is a measurement of a formation property as a function of depth taken by an electrically powered instrument to infer properties and make decisions about drilling and production operations. Measurements obtained in a well log may include resistivity measurements (e.g., borehole resistivity image) obtained by a resistivity measuring tool. In yet another example, the data plot (108-2) may be a plot of a dynamic property, such as the fluid flow rate over time during production operations. Those skilled in the art will appreciate that other data may also be collected, such as, but not limited to, historical data, user inputs, economic information, other measurement data, and other parameters of interest.

In one or more embodiments, the surface unit (202) is communicatively coupled to an exploration and production (EP) computer system (208). In one or more embodiments, the data received by the surface unit (202) may be sent to the EP computer system (208) for further analysis. Generally, the EP computer system (208) is configured to analyze, model, control, optimize, or perform other management tasks of the aforementioned field operations based on the data provided from the surface unit (202). In one or more embodiments, the EP computer system (208) is provided with functionality for manipulating and analyzing the data, such as performing seismic interpretation or well log interpretation to identify geological surfaces in the subterranean formation (104) or performing simulation, planning, and optimization of production operations of the wellsite system (204). Generally, the result generated by the EP computer system (208) is referred to as the exploration and production (EP) data set. In one or more embodiments, the EP data set may be displayed for user viewing using a 2D display, 3D display, or other suitable displays. Although the surface unit (202) is shown as separate from the EP computer system (208) in FIG. 1.1, in other examples, the surface unit (202) and the EP computer system (208) may also be combined.

FIG. 1.2 shows more details of the EP computer system (208) in which one or more embodiments of deviated well log curve grids workflow may be implemented. In one or more embodiments, one or more of the modules and elements shown in FIG. 1.2 may be omitted, repeated, and/or substituted. Accordingly, embodiments of deviated well log curve grids workflow should not be considered limited to the specific arrangements of modules shown in FIG. 1.2.

As shown in FIG. 1.2, the EP computer system (208) includes EP tool (230), data repository (234), and display (233). Each of these elements is described below.

In one or more embodiments, the EP computer system (208) includes the EP tool (230) having software instructions stored in a memory and executing on a processor to communicate with the surface unit (202) for receiving data (e.g., well logs (235)) therefrom and to manage (e.g., analyze, model, control, optimize, or perform other management tasks) the aforementioned field operations based on the received data. In one or more embodiments, the well logs (235) is received by the input module (221) and stored in the data repository (234) to be processed by the EP tool (230). One or more field operation management tasks (e.g., analysis task, modeling task, control task, optimization task, etc.) may be performed in an execution pass of the EP tool (230), referred to as an EP tool session. During the EP tool session, the well logs (235) are manipulated to generate, continuously or intermittently, preliminary and final results that are stored and displayed to the user. For example, the EP tool session may be a well log interpretation session where the extraction module (221), extrapolation module (223), and/or grid generator (234) process the well logs to generate the scatter data set (236), extrapolated data items (240), grid (237), and/or model (238), that are selectively displayed to the user using the display (233). In one or more embodiments, the display (233) may be a 2D display, a 3D display, or other suitable display device. The processor and memory of the EP computer system (208) are not explicitly depicted in FIG. 1.2 so as not to obscure other elements of the EP computer system (208). An example of such processor and memory is described in reference to FIG. 4 below.

In one or more embodiments, the EP tool (230) includes the input module (221) that is configured to obtain the well logs (235) corresponding to a number of deviated wells (e.g., the wellbore (203) of FIG. 1.1) in a portion of the field (104) shown in FIG. 1.1 above. In particular, the well logs (235) represent measured properties of the subterranean formation (104). For example, the data plot (108-2) of FIG. 1.1 may be included in the well logs (235). In one or more embodiments, the measured properties of the well logs (235) may include petrophysical measurements such as gamma particle count rates, sonic waveform travel times, bulk density of the rock minerals and the volume of clay particles in a rock, etc. of the subterranean formation (104). In one or more embodiments, the measured properties of the well logs (235) are sampled periodically (e.g., every 6 inches) along the well paths then stored as an array of unique values referred to as well log samples (i.e., data items of each well log). At the time of acquiring the measured properties, the well log samples do not contain position attributes, such as spatial coordinates (e.g., X, Y, and Z values in a 3D space). Instead, well location and elevation along the well path may be recorded and associated with each well log.

In one or more embodiments, the EP tool (230) includes the extraction module (222) that is configured to extract a section of each well log in the well logs (235). Specifically, the section corresponds to a horizontal leg of a deviated well (e.g., the wellbore (203) of FIG. 1.1). Generally, the deviated well extends from the surface and has one or more near-vertical portions and one or more substantially non-vertical portions. In one or more embodiments, the horizontal leg is a continuous non-vertical portion of the deviated well and lies entirely within a pre-determined depth range traversed by a geological surface (e.g., sandstone layer (106-1), limestone layer (106-2), shale layer (106-3), sand layer (106-4), etc. of FIG. 1.1) in the subterranean formation (104). For example, the pre-determined depth range may be specified by a user. In another example, the pre-determined depth range may be automatically determined according to depth variations of the geological surface over a region of deviated wells in the field (104). Generally, the well log may include measured data corresponding to a portion of the well path beyond the horizontal leg. In one or more embodiments, the section of the well log corresponding to the horizontal leg is extracted by clipping the well log such that measure data in the well log that does not pertain to the horizontal leg is discarded. In one or more embodiments, the clipping is based on a user input identifying the beginning and ending positions (or depths) of the horizontal leg along the well path. In one or more embodiments, the clipping is based on automatically determined beginning and ending positions (or depths) of the horizontal leg along the well path. For example, the beginning and ending positions (or depths) of the horizontal leg may be determined based on the pre-determined depth range traversed by the geological surface. Specifically, the beginning and ending positions (or depths) of the horizontal leg may be determined automatically by calculating where the well path intersects the pre-determined depth range traversed by the geological surface. In other words, the geological surface is within the predetermined depth range and the predetermined depth range is limited so as to include substantially only the depths that have the geological surface.

In one or more embodiments, the EP tool (230) includes the extrapolation module (223) that is configured to extrapolate data items in the section of each well log to generate the extrapolated data items (240). In one or more embodiments, the extrapolated data items (240) may be referred to as scatter data points and represent measured properties of the well logs (235) combined with corresponding spatial coordinates across the geological surface (e.g., sandstone layer (106-1), limestone layer (106-2), shale layer (106-3), sand layer (106-4), etc.). In one or more embodiments, the spatial coordinates corresponding to the measured properties of the well logs (235) are determined by extrapolating, based on well location and elevation along the well path, the recorded depths where the measured properties are acquired. In other words, the spatial coordinates of a particular well log sample are determined based on the well location, elevation along the well path, and the recorded depth of the particular well log sample. In one or more embodiments, the spatial coordinates include X and Y values representing the longitude and latitude position of the log curve sample, and Z value representing the true vertical position of the log curve sample.

In one or more embodiments, the scatter data points of all horizontal legs of the well logs (235) are aggregated into the scatter data set (236), which may be part of an EP data set.

In one or more embodiments, the EP tool (230) includes the grid generator (224) that is configured to generate, using a pre-determined gridding algorithm, the grid (237) based on the data items in the section of each well log in the well logs (235). The grid (237) includes a collection of grid points, where each grid point is associated with a corresponding extrapolated data item in the EP data set described above.

In one or more embodiments, the EP tool (230) includes the model generator (225) that is configured to generate, using a pre-determined modeling algorithm, the model (238) of the geological surface (e.g., sandstone layer (106-1), limestone layer (106-2), shale layer (106-3), sand layer (106-4), etc.) based on the grid (237). As noted above, a field operation may then be performed based on the model (238) of the geological surface.

The data repository (234) may be a data store such as a database, a file system, one or more data structures (e.g., arrays, link lists, tables, hierarchical data structures, etc.) configured in a memory, an extensible markup language (XML) file, any other suitable medium for storing data, or any suitable combination thereof. The data repository (234) may be a device internal to the EP computer system (208) and/or an external storage device operatively connected to the EP computer system (208). The data repository includes functionality to store well logs (235), scatter data set (236), extrapolated data items (240), grid (237), and model (238).

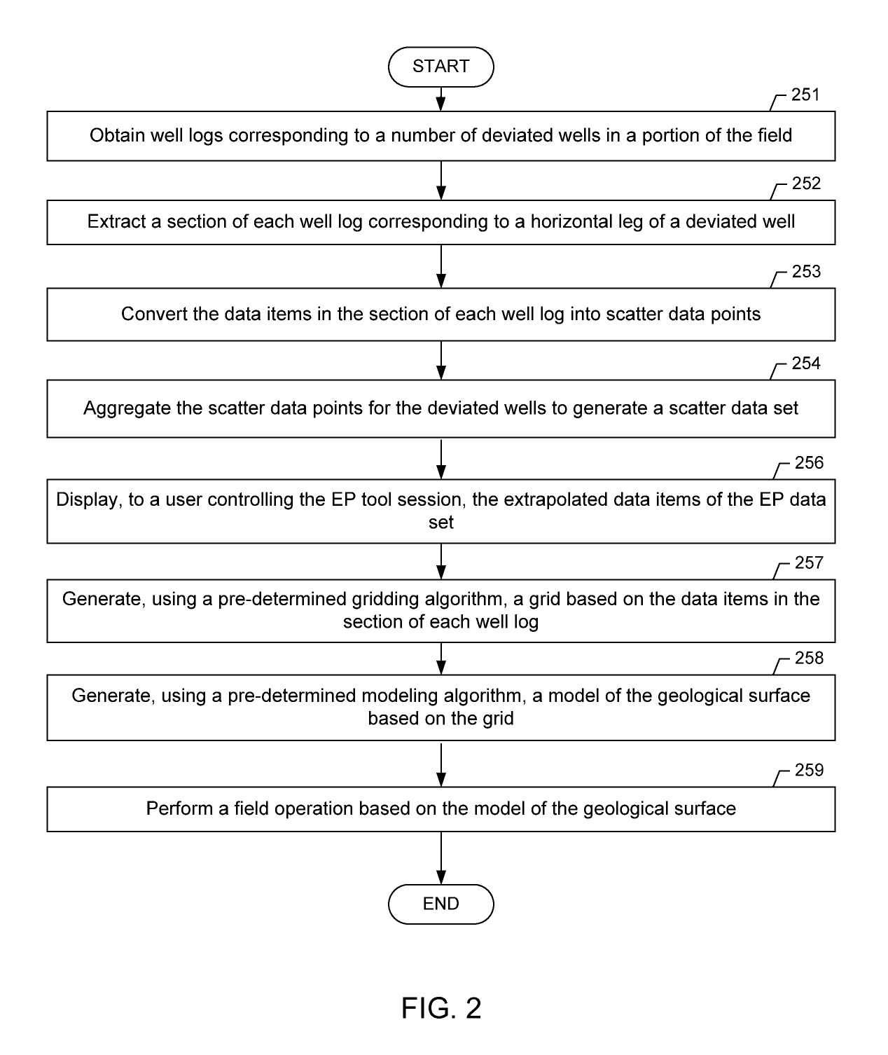

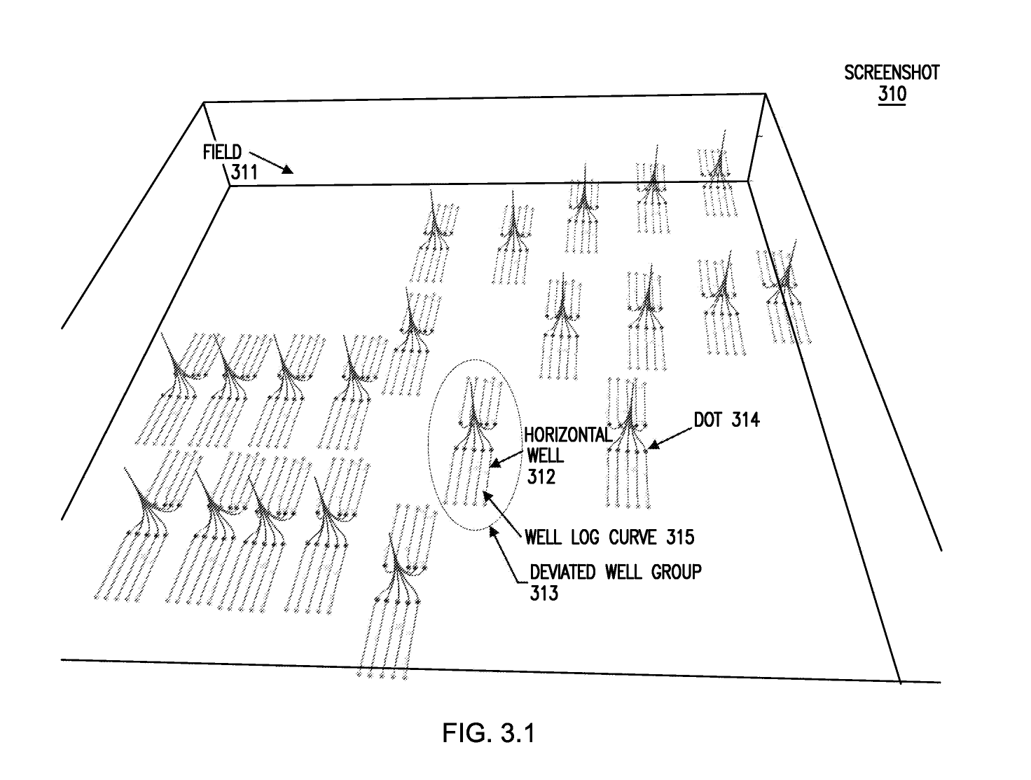

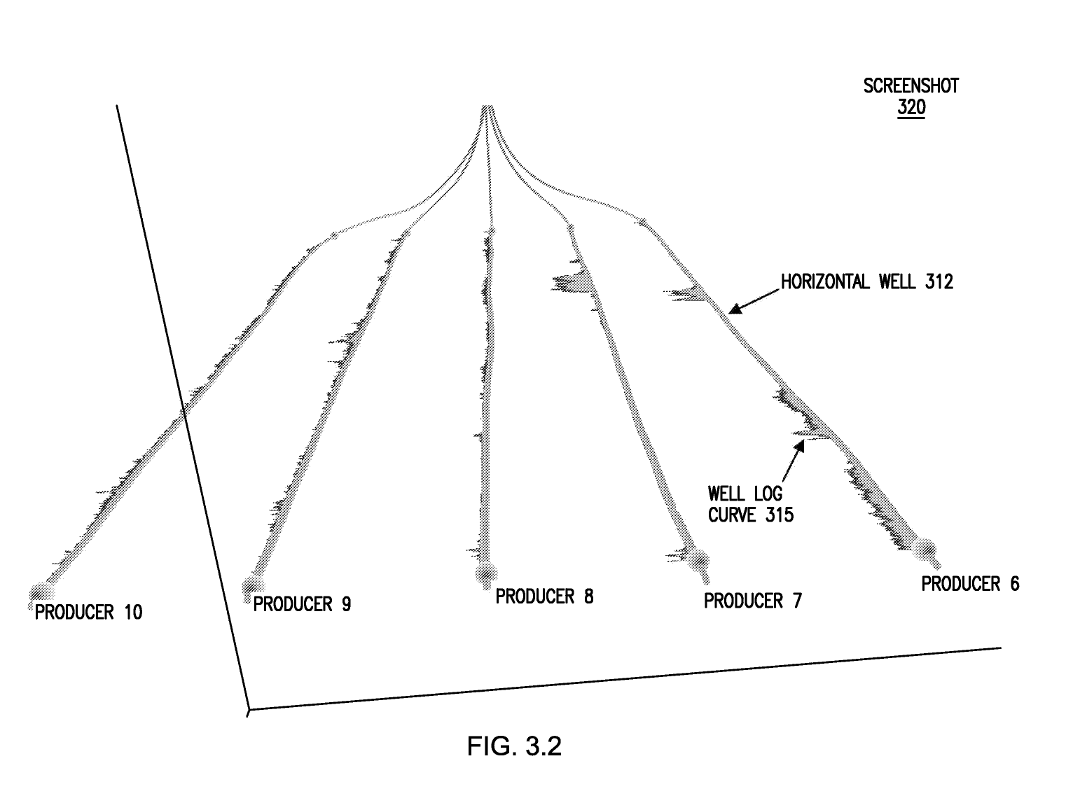

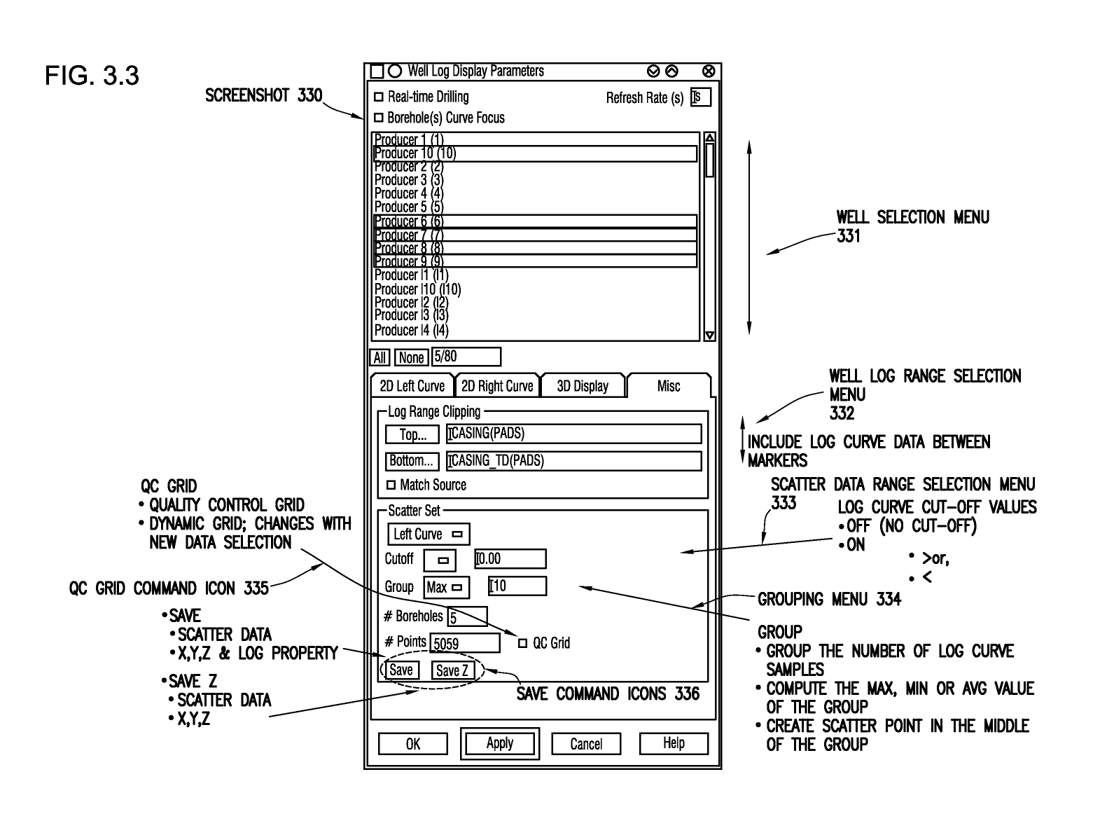

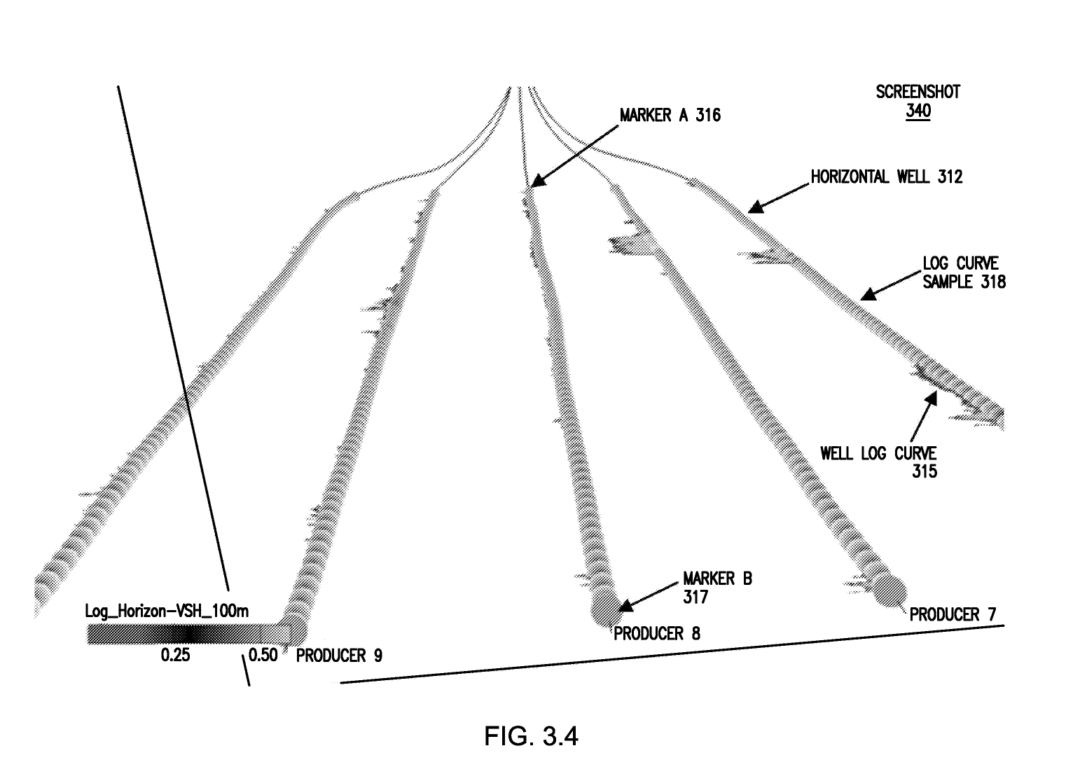

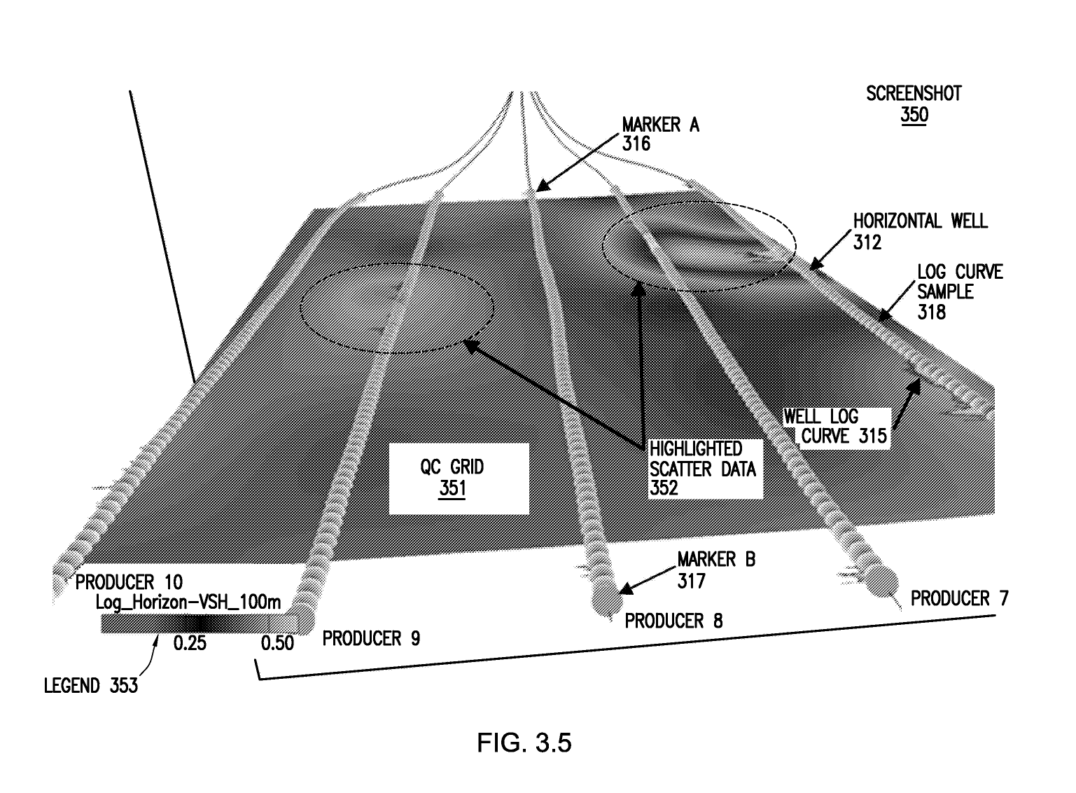

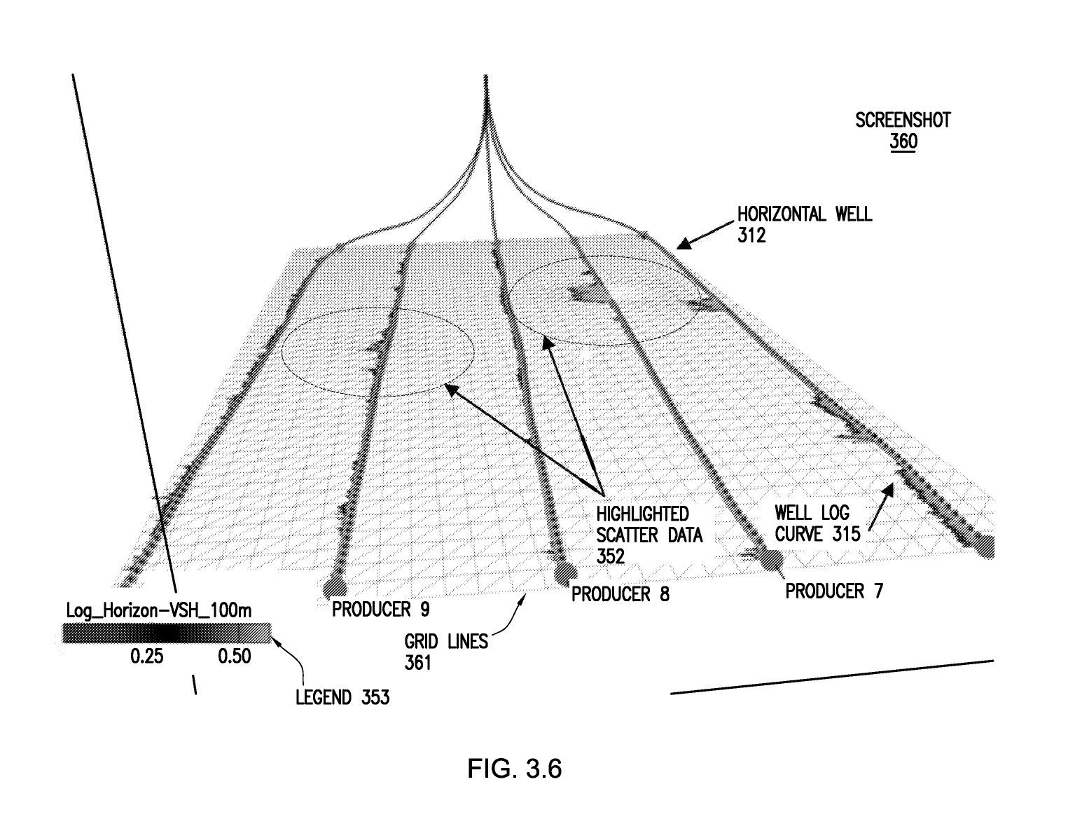

Additional details of the EP computer system (208) are described further in reference to the method depicted in FIG. 2, and the examples depicted in FIGS. 3.1, 3.2, 3.3, 3.4, 3.5, and 3.6 below.

FIG. 2 depicts an example method for deviated well log curve grids workflow in accordance with one or more embodiments. For example, the method depicted in FIG. 2 may be practiced using the EP computer system (258) described in reference to FIGS. 1.1 and 1.2 above. In one or more embodiments, one or more of the elements shown in FIG. 2 may be omitted, repeated, and/or performed in a different order. Accordingly, embodiments of deviated well log curve grids workflow should not be considered limited to the specific arrangements of elements shown in FIG. 2.

Initially in Element 251, well logs are obtained corresponding to a number of deviated wells in a portion of the field, where the well logs represent measured properties of the subterranean formation. For example, the well logs may be obtained by taking measurements using one or more sensors attached to a drill string while drilling the well bores. Specifically, during drilling and/or production operations of the oilfield, various measurements, including well logs, may be obtained and transmitted to the surface unit. The surface unit may send the measurements to the EP computer system for storing in the data repository. Thus, the EP tool may obtain the measurements from the data repository or directly from the oilfield.

In Element 252, a section of each well log is extracted corresponding to a horizontal leg of a deviated well, where the horizontal leg is within a pre-determined depth range traversed by a geological surface in the subterranean formation. In one or more embodiments, the number of deviated wells penetrate the geological surface within the pre-determined depth range. For example, the predetermined depth range may be the same for all of the deviated wells. Accordingly, the various horizontal legs of the deviated wells define a substantially horizontal plane following the contour of the geological surface.

In Element 253, the data items in the section of each well log are converted into scatter data points. In one or more embodiments, the scatter data points are extrapolated data items represent measured properties combined with a corresponding spatial coordinate across the geological surface. While the data items in the well log are referenced along an axis of each well, the scatter data points are referenced based on a three dimensional (3D) coordinate system covering volume defined by the substantially horizontal plane and the pre-determined depth range. In one or more embodiments, the 3D coordinates are determined by extrapolating, based on well location and elevation along the well path, the recorded depths where the measured properties are acquired.

In Element 254, the scatter data points for the deviated wells are aggregated to generate a scatter data set. For example, the scatter data set includes scatter data points that are relatively densely populated along the horizontal leg of each deviated well and relatively sparsely populated in-between the horizontal legs. In one or more embodiments, the scatter data set may be interpolated to complement (i.e., add to) the relatively sparsely populated scatter data set in-between the horizontal legs.

In Element 256, the extrapolated data items of the EP data set is displayed to a user controlling the EP tool session. For example, the user may be performing a reservoir simulation.

In Element 257, using a pre-determined gridding algorithm, a grid is generated based on the data items in the section of each well log. Generally, a grid is a surface defined by points organized in an array of evenly spaced rows and columns. The intersection of the rows and columns define grid points of the grid. In particular, each grid point of the grid is derived from the measured properties and spatial coordinates of nearby log curve samples, for example using linear and/or nonlinear interpolation methods, or other geostatistical approaches. The grid points may be assigned interpolated values of the well log samples.

In Element 258, using a pre-determined modeling algorithm, a model of the geological surface is generated based on the grid. For example, the model may include the grid in a 3D volume having each grid point assigned one or more values of formation properties.

In Element 259, a field operation is performed based on the model of the geological surface. For example, the model may be used in performing simulations of the field. In one or more embodiments, the simulation results may be used to predict downhole conditions, and make decisions concerning oilfield operations. Such decisions may involve well planning, well targeting, well completions, operating levels, production rates and other operations and/or conditions. The information may be used to determine when to drill new wells, re-complete existing wells, or alter wellbore production.

Examples of converting well log curves into scatter data points, aggregating the scatter data points into the scatter data set, extrapolating the scatter data set to generate the EP data set for display to a user, generating the grid and model of the geological surface, and performing the field operation based on the model are described in reference to FIGS. 3.1, 3.2, 3.3, 3.4, 3.5, and 3.6 below.

FIGS. 3.1, 3.2, 3.3, 3.4, 3.5, and 3.6 show examples of deviated well log curve grids workflow in accordance with one or more embodiments. As described in these examples, well log curve values are posted and gridded along horizontal wells in 3D space to QC data and identify trends. A horizontal well is a particular type of deviated well that is substantially horizontal. Log curve values along the horizontal portion of the wells are then saved as scatter points which can be posted in 3D space or in a 2D map that is gridded and contoured to assist the interpreter in determining lithological and rock property trends. The grid generated from the extrapolated scatter points is referred to as a log curve grid. The log curve grid in 3D space is unique in that it is an attribute draped on a geological surface encompassing the horizontal legs of the wells. The assumption is that the wells target a single geological surface in the formation as is done in exploitation of unconventional resources such as shale gas and heavy oil sand plays. In one or more embodiments, the examples described in reference to FIGS. 3.1, 3.2, 3.3, 3.4, 3.5, and 3.6 may be practiced using the EP computer system (208) and the method flowchart described in reference to FIG. 1.2 and FIG. 2 above.

FIG. 3.1 shows a screenshot (310) of an example display representing a portion of a field (311) having a large number of deviated wells in accordance with one or more embodiments. As shown in FIG. 3.1, the horizontal wells are represented by the large number of substantially parallel line segments (e.g., horizontal well (312)) as the horizontal portions of the large number of deviated wells (e.g., deviated well group (313)). More specifically, the two ends of each line segment are marked by a dot (e.g., dot (314)) to represent a horizontal leg of a deviated well. The curved shadings along these line segments represent well log curves (e.g., well log curve (315)).

FIG. 3.2 shows a screenshot (320), which is an expanded portion of the screenshot (310) shown in FIG. 3.1 above. Specifically, the screenshot (320) shows details of the lower portion of the deviated well group (313) depicted in the screenshot (310). Each well has a corresponding well log curve in FIG. 3.2 that shows the values of properties along the well. For example, the horizontal well (312) has corresponding well log curve (315). The five deviated wells are marked as producer 6, producer 7, producer 8, producer 9, and producer 10, respectively.

FIG. 3.3 shows a screenshot (330) of a user interface. Specifically, the screenshot (330) shows a well selection menu (331) for selecting deviated wells, a well log range selection menu (332) for specifying limits of log curve data as top and bottom markers, a scatter data range selection menu (333) for specifying cutoff values of the scatter data, a grouping menu (334) for grouping the log curve samples, a quality control (QC) grid command icon (335) for enabling the QC grid, and save command icons (336) for saving the scatter data in one or more formats. For example, the top and bottom markers may be specified by the user according to the top and bottom of the depth range along the horizontal legs found in the deviated well group (313). In other words, the top and bottom markers define the aforementioned pre-determined depth range.

FIG. 3.4 shows a screenshot (340), which is the screenshot (320) shown in FIG. 3.2 above superimposed with log curve samples (e.g., log curve sample (318)) in-between markers (e.g., marker A (316), marker B (317)) specified using the well log range selection menu (332) shown in FIG. 3.3 above. Specifically, the log curve sample (318) is a data item representing measured values of the well log curve (315). These log curve samples are no longer organized as curves along well paths, instead the log curve samples are referenced based on a three dimensional coordinate system. For example, the log curve may initially include measured values of the formation indexed by a depth along the well path, while the log curve samples are the measured values indexed by three dimensional coordinates of a volume encompassing the well paths. The log curve data samples of horizontal wells are collectively referred to as a scatter data set.

FIG. 3.5 shows a screenshot (350), which is the screenshot (340) shown in FIG. 3.4 above superimposed with the QC grid (351) that is enabled using the (QC) grid command icon (335) shown in FIG. 3.3 above. Specifically, the QC grid (351) includes, in-between horizontal wells, scatter data points that are interpolated/extrapolated from the scatter data set (i.e., log curve samples of horizontal wells) based on a pre-determined grid resolution. The scatter data points are extrapolated data items assigned to grid cells referenced based on a three dimensional coordinate system covering at least a substantially horizontal plane defined by the horizontal wells. These grid cells have very small cell sizes that are not individually identified in the screenshot (350). As shown in FIG. 3.5, the scatter data points may be color coded or otherwise represented by highlighting patterns according to the legend (352). For example, certain portion of the QC grid (351) are shown as the highlighted scatter data (352). In particular, the highlighted scatter data (352) covers a portion of the QC grid (351) where measured values of the formation as represented by the scatter data points are readily distinguishable from the neighboring portions of the QC grid (351). In other words, the screenshot (350) is an example of presenting predictions of the formation property such that important features of the formation may be readily observable without requiring the user to manually comparing adjacent well log curves to identify important trends.

FIG. 3.6 shows a screenshot (360), which is the screenshot (350) shown in FIG. 3.5 except that the QC grid (351) is replaced by the grid lines (361) showing locations of the grid points of the QC grid (351). In particular, the screenshot (350) is a directional vector presentation of the gridded data away from the grid points. The grid lines (361) are provided as a visual reference to the data trends away from the grid points.

Embodiments of horizontal well log curve grids workflow may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of horizontal well log curve grids workflow. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device. The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of horizontal well log curve grids workflow may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by computer processor(s), is configured to perform embodiments of horizontal well log curve grids workflow.

Further, one or more elements of the aforementioned computing system (400) may be located at a remote location and connected to the other elements over a network (412). Further, embodiments of horizontal well log curve grids workflow may be implemented on a distributed system having a plurality of nodes, where each portion of horizontal well log curve grids workflow may be located on a different node within the distributed system. In one embodiment of horizontal well log curve grids workflow, the node corresponds to a distinct computing device. The node may correspond to a computer processor with associated physical memory. The node may correspond to a computer processor or micro-core of a computer processor with shared memory and/or resources.

The systems and methods provided relate to the acquisition of hydrocarbons from an oilfield. It will be appreciated that the same systems and methods may be used for performing subsurface operations, such as mining, water retrieval, and acquisition of other underground fluids or other geomaterials from other fields. Further, portions of the systems and methods may be implemented as software, hardware, firmware, or combinations thereof.

While horizontal well log curve grids workflow has been described with respect to a limited number of embodiments, those skilled in the art, having benefit of this disclosure, will appreciate that other embodiments can be devised which do not depart from the scope of horizontal well log curve grids workflow as disclosed herein. Accordingly, the scope of horizontal well log curve grids workflow should be limited only by the attached claims.

What is claimed is:

1. A method for displaying an exploration and production (EP) data set during an EP tool session of a field having a subterranean formation, comprising:
obtaining a plurality of well logs corresponding to a plurality of deviated wells in a portion of the field, wherein the plurality of well logs represent measured properties of the subterranean formation;
extracting, by a computer processor, a section of each well log of the plurality of well logs, the section corresponding to a horizontal leg of a deviated well of the plurality of deviated wells, wherein the horizontal leg is within a pre-determined depth range traversed by a geological surface in the subterranean formation;
extrapolating, by the computer processor, a plurality of data items in the section of each well log to generate a plurality of extrapolated data items forming the EP data set, wherein the plurality of extrapolated data items represent the measured properties combined with a corresponding spatial coordinate across the geological surface; and
displaying the plurality of extrapolated data items of the EP data set.

2. The method of claim 1, wherein extrapolating the plurality of data items comprises:
converting the plurality of data items in the section of each well log into a plurality of scatter data points corresponding to the plurality of extrapolated data items; and
aggregating the plurality of scatter data points for the plurality of deviated wells to generate a scatter data set,
wherein the corresponding spatial coordinate is determined based on a well location, an elevation along a well path, and a recorded depth associated with the measured properties.

3. The method of claim 1, further comprising:
generating, using a pre-determined gridding algorithm, a grid based on the plurality of data items in the section of each well log,
wherein the grid comprises a plurality of grid points, and
wherein each grid point is associated with an extrapolated data item of the plurality of extrapolated data items.

4. The method of claim 3, further comprising:
generating, by the computer processor using a pre-determined modeling algorithm, a model of the geological surface based on the grid; and
performing a field operation based on the model of the geological surface.

5. The method of claim 1, further comprising:
receiving user specified markers from a user,
wherein the horizontal leg of the deviated well is identified based on the user specified markers.

6. The method of claim 1,
wherein the plurality of deviated wells penetrate the geological surface within the pre-determined depth range.

7. The method of claim 1, further comprising:
displaying the plurality of extrapolated data items of the EP data set in a quality control grid with reduced resolution.

8. A computer system for obtaining an exploration and production (EP) data set during an EP tool session of a field having a subterranean formation, comprising:
a processor and memory; and
an EP tool stored in the memory, executing on the processor, and comprising:
an input module configured to obtain a plurality of well logs corresponding to a plurality of deviated wells in a portion of the field, wherein the plurality of well logs represent measured properties of the subterranean formation;
an extraction module configured to extract a section of each well log of the plurality of well logs, the section corresponding to a horizontal leg of a deviated well of the plurality of deviated wells, wherein the horizontal leg is within a pre-determined depth range traversed by a geological surface in the subterranean formation; and
an extrapolation module configured to extrapolate a plurality of data items in the section of each well log to generate a plurality of extrapolated data items forming the EP data set, wherein the plurality of extrapolated data items represent the measured properties combined with a corresponding spatial coordinate across the geological surface; and
a repository configured to store the plurality of well logs and the plurality of extrapolated data items.

9. The system of claim 8, further comprising:
a display device configured to display the plurality of extrapolated data items of the EP data set to a user controlling the EP tool session.

10. The system of claim 8, wherein extrapolating the plurality of data items comprises:
converting the plurality of data items in the section of each well log into a plurality of scatter data points corresponding to the plurality of extrapolated data items; and
aggregating the plurality of scatter data points for the plurality of deviated wells to generate a scatter data set,
wherein the corresponding spatial coordinate is determined based on a well location, an elevation along a well path, and a recorded depth associated with the measured properties, and
wherein the repository is further configured to store the scatter data set.

11. The system of claim 8, wherein the EP tool further comprises:
a grid generator configured to generate, using a pre-determined gridding algorithm, a grid based on the plurality of data items in the section of each well log,
wherein the grid comprises a plurality of grid points, and
wherein each grid point is associated with an extrapolated data item, and
wherein the repository is further configured to store the grid.

12. The system of claim 11, wherein the EP tool further comprises:
a model generator executing on the processor and configured to generate, using a pre-determined modeling algorithm, a model of the geological surface based on the grid,
wherein a field operation is performed based on the model of the geological surface, and
wherein the repository is further configured to store the model of the geological surface.

13. The system of claim 8, the input module further configured to:
receive user specified markers from a user,
wherein the horizontal leg of the deviated well is identified based on the user specified markers.

14. The system of claim 8,
wherein the plurality of deviated wells penetrate the geological surface within the pre-determined depth range.

15. The system of claim 9, the displayed device further configured to:
displaying the plurality of extrapolated data items of the EP data set in a quality control grid with reduced resolution.

16. A non-transitory computer readable medium comprising instructions for displaying an exploration and production (EP) data set during an EP tool session of a field having a subterranean formation, the instructions when executed by a computer processor comprising functionality for:
obtaining a plurality of well logs corresponding to a plurality of deviated wells in a portion of the field, wherein the plurality of well logs represent measured properties of the subterranean formation;
extracting a section of each well log of the plurality of well logs, the section corresponding to a horizontal leg of a deviated well of the plurality of deviated wells, wherein the horizontal leg is within a pre-determined depth range traversed by a geological surface in the subterranean formation;
extrapolating a plurality of data items in the section of each well log to generate a plurality of extrapolated data items forming the EP data set, wherein the plurality of extrapolated data items represent the measured properties combined with a corresponding spatial coordinate across the geological surface;
displaying the plurality of extrapolated data items of the EP data set.

17. The non-transitory computer readable medium of claim 16, wherein extrapolating the plurality of data items comprises:
converting the plurality of data items in the section of each well log into a plurality of scatter data points corresponding to the plurality of extrapolated data items; and
aggregating the plurality of scatter data points for the plurality of deviated wells to generate a scatter data set,
wherein the corresponding spatial coordinate is determined based on a well location, an elevation along a well path, and a recorded depth associated with the measured properties.

18. The non-transitory computer readable medium of claim 16, the instructions when executed by the computer processor further comprising functionality for:
generating, using a pre-determined gridding algorithm, a grid based on the plurality of data items in the section of each well log,
wherein the grid comprises a plurality of grid points, and
wherein each grid point is associated with an extrapolated data item.

19. The non-transitory computer readable medium of claim 18, the instructions when executed by the computer processor further comprising functionality for:
generating, using a pre-determined modeling algorithm, a model of the geological surface based on the grid; and
performing a field operation based on the model of the geological surface.

20. The non-transitory computer readable medium of claim 16, further comprising:
wherein the plurality of deviated wells penetrate the geological surface within the pre-determined depth range.
